(19) United States
(12) Patent Application Publication
(10) Pub. No.: US 2013/0064321 A1
(43) Pub. Date: Mar. 14, 2013

(54) METHODS FOR ASYNCHRONOUS SERIAL DATA TRANSMISSION USING A SYNCHRONOUS SERIAL INTERFACE

(71) Applicant: Manfred Kopp, Wolfach (DE)

(72) Inventor: Manfred Kopp, Wolfach (DE)

(73) Assignee: VEGA

(21) Appl. No.: 13/554,415

(22) Filed: Jul. 20, 2012

(30) Foreign Application Priority Data
Sep. 14, 2011 (EP) EP 11 181 217.8

(51) Int. Cl. H04L 27/00

(52) U.S. Cl. 375/295

(57) ABSTRACT

The invention relates to a method for the unidirectional, asynchronous serial data transfer with an asynchronous data format with F frame bits between a transmitting interface of a data transmitting device and between a data receiving device with a serial receiving interface comprising an asynchronous serial data input. It is provided that the transmitting interface is constructed as a synchronous serial interface with at least one data line, whereby the data line is connected to the asynchronous serial data input of the receiving interface, a data word with D data bits to be transmitted by the data transmitting device in order to generate a format with F frame bits corresponding to the asynchronous data format is supplemented. The data word supplemented with the frame bits is stored in a transmitting register for transmission to the data receiving device.

### CROSS-REFERENCE TO RELATED APPLICATIONS

This application claims priority from European Patent Application Serial No. 11 181217.8 filed on Sep. 14, 2011 for “Method for the Asynchronous, Serial Data Transfer by a Synchronous, Serial Interface”, the entire contents of which is incorporated herein fully by reference.

### BACKGROUND OF THE INVENTION

1. Field of the Invention

The invention relates to a method for the unidirectional, asynchronous serial data transfer with an asynchronous data format with F frame bits between a transmitting interface of a data transmitting device and between a data receiving device with a serial receiving interface comprising an asynchronous serial data input.

2. Description of the Related Art

The communication or the data transfer between microcomputers or between a microcomputer and a peripheral device takes place either serially or in parallel, in which data is received and transmitted in parallel per data unit. In a serial data transfer, a distinction is made between a synchronous serial method, in which the passage of time or the control of time for a synchronization between the transmitting side and the receiving side apparatus by a clock pulse made available from the transmitting side, and an asynchronous serial method, in which the data transfer takes place without a clock pulse. A serial data transfer, e.g., according to the SPI protocol, takes place via three lines, namely, via a transmitting line (MOST), a receiving line (MISO) and a clock line (SCLK). In addition to these three lines a slave select (SS), or also called chip select (CS), line is required through which the transmitting unit as master selects the slave for the actual communication.

An asynchronous serial data format is a character-oriented data format in which each data word is provided before the transfer with control and security signaling information such as start bit, stop bit and/or parity bit and is supplemented to a uniform character frame. The time span between two successive character frames can be as desired, because each data word supplemented in this manner is closed in itself and the formatting (synchronization) begins with each new character frame. For the transfer of a data word in accordance with such an asynchronous serial data format, e.g., according to the UART (Universal Asynchronous Receiver/Transmitter) standard, a start bit is added at the beginning and a stop bit at the end of the data word to be transmitted as a control character. The start bit indicates to the receiver that the data word is to be transmitted and the receiver can synchronize itself for the data transfer. According to this UART standard, a start bit, the 8 data bits, and 1 to 2 stop bits are transferred for one data byte. The second stop bit is necessary according to the design of the UART intersection if the transmitter is somewhat more rapid than the receiver. The most important use of the UART standard are intersections such as RS232 or RS485.

For example, data transfers using the UART standard even between or within devices in the application area of pressure technology or level measuring technology are used, e.g., in sensors, actors, field devices, measuring devices, evaluation devices, communication devices and operating devices. In order to carry out asynchronous serial data transfers, e.g., via an RS232 interface, it was previously necessary to install a microprocessor connected to a UART interface in the device or to use a microcontroller containing a serial interface with UART capabilities, during which the D data bits to be transferred are written as a data word into a transmitting register that is then automatically supplemented by a hardware unit by F frame bits (framing bits) and transmitted in the fixed sequence in time together as N bits via a shift register.

The asynchronous serial data transfer can be selectively executed bit for bit with software if no UART interface is present, i.e., the control of an output line with the N bit states to be transmitted at times fixed by the asynchronous hardware protocol, also called “bit-banging”. Disadvantages of a software solution with “bit-banging” are an additional program memory requirement, an additional processor computing power requirement, and additional software error sources in the case of elevated demands on the reliability.

### SUMMARY OF THE INVENTION

The present invention has the task of creating a method for the unidirectional, asynchronous serial data transfer of the initially cited type that requires no data transmitting device with a UART interface and that requires only a low software expenditure for its realization. This task is solved by the method according to the invention. Such a method for the unidirectional, asynchronous serial data transfer with an asynchronous data format with F frame bits between a transmitting interface of a data transmitting device and between a data receiving device with a serial receiving interface comprising an asynchronous serial data input is distinguished in that the transmitting interface is constructed as a synchronous serial interface with at least one data line, whereby the data line is connected to the asynchronous serial data input of the receiving interface. Furthermore, a data word with D data bits to be transmitted by the data transmitting device in order to generate a format with F frame bits corresponding to the asynchronous data format is supplemented, and subsequently the data word supplemented with the frame bits is stored in a transmitting register for transmission to the data receiving device.

With this method in accordance with the invention it is not necessary for the transmitting capacity of the data transmitting device, e.g., a microcomputer, to set up a hardware interface with asynchronous serial data transmission if, instead of this, a hardware interface with synchronous serial data transmission is present. Thus, there is the possibility of using a microcomputer or microcontroller as a data transmission device that has no asynchronous serial transmitting interface, e.g., a UART interface, and is thus more economical or has other indispensable properties without having to carry out an asynchronous, serial data transmission in the transmitting direction by software (“bit-banging”). The clock pulses produced by the synchronous serial interface are not required in this method according to the invention and can therefore be used for alternative tasks.

Therefore, the method in accordance with the invention requires less software expense with lesser complexity so that fewer error sources are produced and therefore even the safety integrity level (SIL) testing of this simpler software is more economical. Even the advantage of a lower computer power and of a lesser program memory requirement for carrying out this method in accordance with the invention is connected to this. Finally, the use of this method in accordance with the invention can have the result that tasks can be carried out with microcomputers or microcontrollers that would otherwise be overtaxed with such tasks on account of their scant hardware resources.

An advantageous embodiment of the invention provides that after a transmission of the data word in the asynchronous data format on the data line the logical level corresponding to the last bit of this data word remains until a next data word is transmitted in the asynchronous data format in order ensure an unambiguous and secure synchronization with the data transmission of the data receiving device.

It is especially advantageous according to a further development of the invention if the synchronous serial interface can transmit a serial data transmission with N bits, e.g., with N=10 (1 byte), synchronously with a transmitter bit timing of this interface so that in order to transmit a data word in the asynchronous data format of a data transmitting device, e.g., with D=8data bits and F frame bits, the N bits to be transmitted result. A start bit is preferably set at the start of the data word to be transmitted and a stop bit is set at the end of the data word to be transmitted with F=2 as frame bits. According to a further development, the data word to be transmitted can be additionally supplemented with a parity bit with F=3 in addition to the start bit and the stop bit so that a serial data transmission capability of the synchronous serial interface with D=11 would be necessary for this.

There is also the possibility according to a further development of constructing the synchronous serial interface as a Serial Peripheral Interface (SPI) interface since its use is widely known. If this synchronous serial interface is constructed for the asynchronous serial data transmission in accordance with the UART standard in such a manner that the data transmission begins with the lowest-value bit (LSB), a software mirroring of the data word to be transmitted can be eliminated since according to the UART standard the data transmission always begins with the lowest-value bit.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows a schematic view of a transmitter-receiver arrangement for the asynchronous serial data transmission according to the method in accordance with the invention;

FIG. 2 shows a schematic view of a flowchart for generating a data word corresponding to the UART standard; and

FIG. 3 shows a time-level diagram of a data word to be transmitted in accordance with the UART standard and the associated clock pulse.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

Referring first to FIG. 1, the data transmission device 10 is constructed as a microcomputer and has an SPI interface 11 as a serial interface that is connected in the master mode for the data transmission in accordance with the UART standard via a data line 12 to another microcomputer as data receiving device 20. This microcomputer 20 has as its interface a UART interface 21 with a data input 22.

The SPI interface 11 comprises in the simplest case at least one shift register 11a as transmitting register and has a data output MOSI (also called serial data output (SDO)) connected to the data line 12, whereby the customarily provided data input MISO for the second data line is not shown. Furthermore, two control lines 13 and 14 of this SPI interface 10 are shown that correspond to the clock line CLK and to the slave select (SS), also called chip select (CS). The two control lines 13 and 14 are not connected to the UART interface 21 of the data receiving device 20.

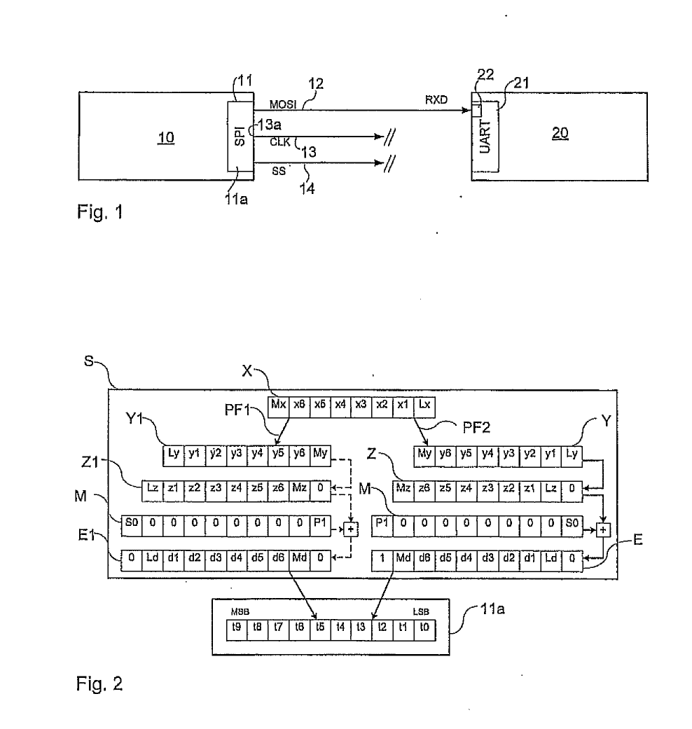

This SPI interface 11 permits a synchronous serial data transfer of at least N=10 data bits with its transmitter bit timing CLK. The transfer of a data word in the asynchronous data format in accordance with the UART standard via the data line 12 to the UART interface 21 of the microcomputer 20 is explained in the following in conjunction with FIG. 2.

Turning to FIG. 2, shown is a schematic view of a flowchart for generating a data word corresponding to the UART standard. The generation of a binary data word in the asynchronous UART data format from a data word X to be transmitted with D=8 data bits X (0) . . . X (D−1) is carried out in a software block S of the SPI interface 11.

According to FIG. 2, two paths PF1 and PF2 are shown in the software block S. Since in the UART standard the data transmission always begins with the lowest-value data bit (LSB), the data word X must, if necessary, be mirrored according to path PF1 into the data word Y1 with 8 data bits Y1 (0), . . . Y1 (D−1). If the data word X is already present in the correct sequence it is assumed as data word Y with 8 data bits Y (0) . . . Y (D−1).

In the following step, the data words Y1 and Y are each supplemented with a bit 0 in both paths PF1 and PF2 with 0 as the new last bit, which corresponds to a multiplication of the data word Y1 or Y by 2: Z1=2*Y1 and Z=2*Y. This procedure corresponds to a left shift of the data word Y1 or Y in a shift register. The two data words Z1 and Z are subsequently supplemented by linking with a bit mask M with two frame bits, one start bit SO and one stop bit P1 so that the data word E1 or E to be transmitted is present in the asynchronous serial UART data format, whereby the bit value of the start bit SO always has the value 0 and the bit value of the start bit P1 always has the value 1.

This data word E1 or E is shifted into the shift register 11a from which as transmitting register of the SPI interface 11 this data word is serially read out in the transmitter bit timing of the SPI interface for transmission via the data line 12 to the UART interface 21 of the microcomputer 20. With a transmitter bit timing of 2400 Hertz (Hz) a bit rate of 2400 baud is achieved. This transmitter bit timing can also be selected in such a manner that baud rates of 1200 or 4800 are produced.

The SPI interface 11 is preferably designed in such a manner that the level on the data line 12 after the transmission of the data word E1 or E remains at the level of the last transmitted bit. Therefore, the stop bit with the bit value 1, that is, does not change until the transmission of the next data word to the level value of the start bit with the bit value 0. Alternatively, this can also be realized with the microcontroller 10 in that it assumes the monitoring over the data line 12 so that after a data transmission up to the next data transmission the rest state corresponding to the level value 1 is retained.

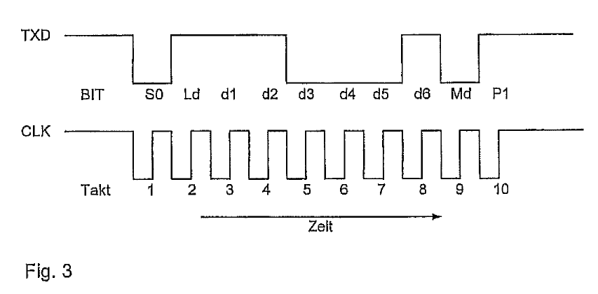

Referring next to FIG. 3, shown is an exemplary level course TXD on the data line 12 of a data word E or E1, supplemented with a start bit S0 and a stop bit P1 according to the UART standard, with the data bits d0, . . . d7 with associated clock pulse CLK so that the data transmission begins with the lowest-value bit (LSB). In particular, it can be recognized from this FIG. 3 that in the state of rest the level on the data line 12 is at the level value 1 corresponding to the stop bit P1.

In the exemplary embodiment explained above only one start bit and one stop bit are added to the data word to be transmitted in order to generate the asynchronous data format. Accordingly, a parity bit can also be added to the data word to be transmitted which parity bit is inserted before the stop bit. In this case, for the supplementation with F=3 frame bits, the SPI interface 11 for transmitting a data word with D=8 data bits must be designed in such a manner that N=11 bits can be transmitted serially without interruption.

The connections for the further data line MISO (SDI) that are not necessary in the asynchronous serial data transmission according to the UART standard and the control lines CLK and SS (Slave Select, also called CS: Chip Select) can be used for alternative tasks if the hardware is set for this.

### LIST OF REFERENCE NUMERALS

10 data transmitting device, microcomputer
11 transmitting interface, SPI interface
11a shift register, transmitting register of the transmitting interface 11
12 data line
13 control line, clock line
13a clock output
14 control line, SS line
20 data receiving device, microcomputer
21 receiving interface, UART interface
22 data input of the receiving interface 21
M bit mask
E data word
E1 data word
X data word
Y data word
Y1 data word
Z data word
Z1 data word.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method for the unidirectional, asynchronous serial data transfer with an asynchronous data format with F frame bits between a transmitting interface of a data transmitting device and between a data receiving device with a serial receiving interface comprising an asynchronous serial data input, said method comprising the steps of:
constructing a transmitting interface as a synchronous serial interface with at least one data line, whereby the data line is connected to the asynchronous serial data input of the receiving interface;
supplementing a data word with D data bits to be transmitted by the data transmitting device in order to generate a format with F frame bits corresponding to the asynchronous data format; and
storing the data word supplemented with the frame bits in a transmitting register for transmission to the data receiving device.

2. The method according to claim 1, wherein after a transmission of the data word in the asynchronous data format on the data line a logical level corresponding to the last bit of the data word remains until a next data word is transmitted in the asynchronous data format.

3. The method according to claim 1, wherein the synchronous serial interface is designed to transmit a serial data transmission of N bits synchronously with a transmitter bit timing of the synchronous serial interface, whereby in order to transmit a data word in the asynchronous data format D data bits and F frame bits result in N bits to be transmitted.

4. The method according to claim 3, wherein a start bit is placed on a start of the data word to be transmitted and one or more stop bit(s) are placed on an end of the data word to be transmitted as frame bits.

5. The method according to claim 4, wherein the data word to be transmitted is additionally supplemented with a parity bit in addition to the start bit and one or more stop bit(s).

6. The method according to claim 1, wherein the synchronous serial interface is designed as an SPI (Serial Peripheral Interface) interface.

7. The method according to claim 1, wherein the synchronous serial interface is designed in such a manner that the data transmission begins with the lowest-value bit (LSB).

8. The method according to claim 1, wherein the data word to be transmitted is assembled in such a manner that the data transmission begins with the lowest-value bit (LSB).

9. The method according to claim 1, wherein the asynchronous data format corresponds to the UART (Universal Asynchronous Receiver/Transmitter) standard.

10. The method according to claim 1, wherein said method is used in a device selected from the group consisting of a sensor, an actor, a field device, a measuring device, an evaluation device, an operating device, and a communication device.

11. A system for the unidirectional, asynchronous serial data transfer between a transmitting interface of a data transmitting device and a data receiving device with a serial receiving interface comprising an asynchronous serial data input, wherein said system comprises:
a transmitting interface constructed as a synchronous serial interface with at least one data line, wherein said data line is connected to an asynchronous serial data input of a receiving interface; and
a data word with D data bits to be transmitted by said data transmitting device in order to generate a format with F frame bits corresponding to an asynchronous data format;
wherein said data word is supplemented with said F frame bits and is stored in a transmitting register for transmission to a data receiving device.

12. The system according to claim 11, wherein after a transmission of said data word in said asynchronous data format on said data line a logical level corresponding to a last bit of said data word remains until a next data word is transmitted in said asynchronous data format.

13. The system according to claim 11, wherein said synchronous serial interface is designed to transmit a serial data transmission of N bits synchronously with a transmitter bit timing of said synchronous serial interface, whereby in order to transmit said data word in said asynchronous data format D data bits and F frame bits result in N bits to be transmitted.

14. The system according to claim 13, wherein a start bit is placed on a start of said data word to be transmitted and one or more stop bit(s) are placed on an end of said data word to be transmitted as frame bits.

15. The system according to claim 14, wherein said data word to be transmitted is additionally supplemented with a parity bit in addition to said start bit and one or more stop bit(s).

16. The system according to claim 11, wherein said synchronous serial interface is designed as an SPI (Serial Peripheral Interface) interface.

17. The system according to claim 11, wherein said synchronous serial interface is designed in such a manner that said data transmission begins with a lowest-value bit (LSB).

18. The system according to claim 11, wherein said data word to be transmitted is assembled in such a manner that said data transmission begins with a lowest-value bit (LSB).

19. The system according to claim 11, wherein said asynchronous data format corresponds to a UART (Universal Asynchronous Receiver/Transmitter) standard.

20. The system according to claim 11, wherein said system is employed with a device selected from the group consisting of a sensor, an actor, a field device, a measuring device, an evaluation device, an operating device, and a communication device.
